(19) United States
(12) Patent Application Publication
(10) Pub. No.: US 2011/0202429 A1
(43) Pub. Date: Aug. 18, 2011

(54) OBJECT TRACKING SYSTEM WITH NARRATIVE

(76) Inventors: Dori Graff, St. Paul, MN (US); Mary Fallon, Minneapolis, MN (US)

(21) Appl. No.: 13/026,100

(22) Filed: Feb. 11, 2011

Related U.S. Application Data
(60) Provisional application No. 61/304,202, filed on Feb. 12, 2010.

(51) Int. Cl. G06Q 30/00; G06F 3/01; G06F 15/16

(52) U.S. Cl. 705/26.61; 715/733; 715/743

(57) ABSTRACT

A method and system records, tracks, and shares the stories of objects as they pass from one person to the next. The process begins offline when the originator of the item places a tracking code on an object. The specific object is tied to the unique code in a database once the originator creates an item page online. When creating the item page, the originator uploads a photo and provides additional information about the object including his or her personal story about the item. The originator then sells or gives the object to another user who uses the tracking code to access this information and add additional information and an optional photo. This process results in the creation of a co-authored “life story” of the object that connects people associated with the item.

### RELATED APPLICATION

This application claims priority under 35 U.S.C. 119(e) to U.S. Provisional Application Ser. No. 61/304,202, entitled Object Tracking System with Narrative, filed Feb. 12, 2010, which is incorporated herein by reference in its entirety.

### BACKGROUND

Currently, a handful of products have tracking codes that enable consumers to access information about the origins of the item. The consumer may read the information.

### SUMMARY

A method includes fixing a tracking tag with a unique tracking identification tag on a physical item to be tracked as possession of the item changes between persons. An item page accessible by a network is created. The item page includes an item name, location, item type, and narrative about the item. When passing the item to another person, the person is allowed to access the item page via the tracking identification tag and add narrative. All future possessors of the item are permitted to view the item page and add to the narrative.

### BRIEF DESCRIPTION OF THE DRAWINGS

FIG. 1 is a block flow diagram of a system to track a life of an item as it is used and transferred to other according to an example embodiment.

FIG. 2 is a chart illustrating various stages of an item in the context of a system according to an example embodiment.

FIG. 3 is a block flow diagram illustrating operation of system components during stages according to an example embodiment.

FIG. 4 is a block diagram of a process of tracking an item and creating an item page with narrative according to an example embodiment.

FIG. 5 is a block diagram illustrating a site path for an originator of an item and item page according to an example embodiment.

FIG. 6 is a block diagram illustrating a site path for a recipient of an item with an item page according to an example embodiment.

FIG. 7 is a screenshot of an add item page according to an example embodiment.

FIG. 8 is a screenshot of an example item page with narrative according to an example embodiment.

FIG. 9 is a block diagram of an example computer system for hosting and interacting with a site for tracking items according to an example embodiment.

FIGS. 10A, 10B, and 10C are screenshots of an alternative add item page according to an example embodiment.

FIG. 11 is a screenshot of an alternative item page with narrative according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof stored on a storage device. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

While some manufacturers provide websites with information about the products they sell, such websites do not allow consumers of the products to add information related to the particular product that they purchased. A system and method is provided to enable a purchaser of an item to add to information related to the product via a website. A story and narrative may be read and added to by people who are tied to the object. Other web sites exist that enable a group of people to co-author a story about themselves or an event, but do not tie storytelling to an object in the offline world through the use of tracking codes.

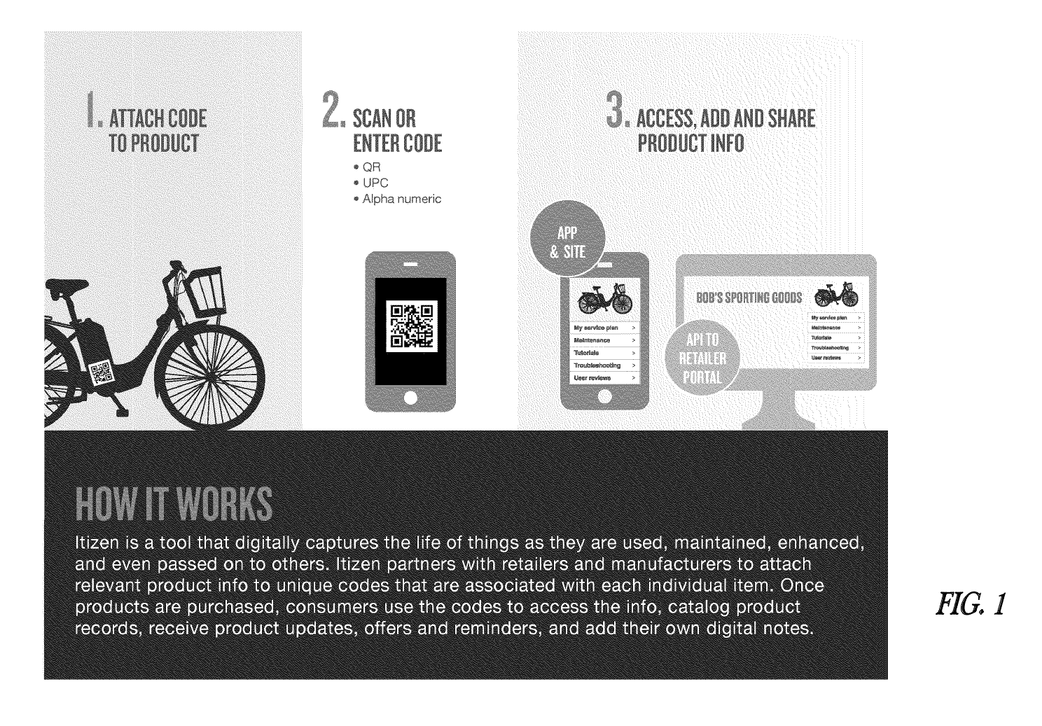

FIG. 1 is a block flow representation of a system that digitally captures the life of things as they are used, maintained, enhanced, and even passed on to others. The system may include relationships with retainers and manufacturers to attach relevant product information to unique codes that are associated with each individual item. Once products are purchased or otherwise obtained, consumers may use the codes to access the information, catalog product records, receive product updates, offers and reminders, and add their own digital notes, including narratives and other content, such as images, video, and audio content.

In operation, a code is attached to the product, such as a bicycle as shown. The consumer may scan or enter the code into a digital appliance such as a cell phone or other device. The code in various embodiments is a QR code, a UPC code, or some other alpha numeric code. The code is then used to access, add, and share information about the product via a website or other network construct that is capable of storing and providing information. In one embodiment, the website provides information such as a service plan, maintenance, tutorials, troubleshooting, user reviews and other information in addition to the ability of consumers to contribute even more information. As illustrated in FIG. 1, an application program interface may be added to a retailer portal to provide more information about products.

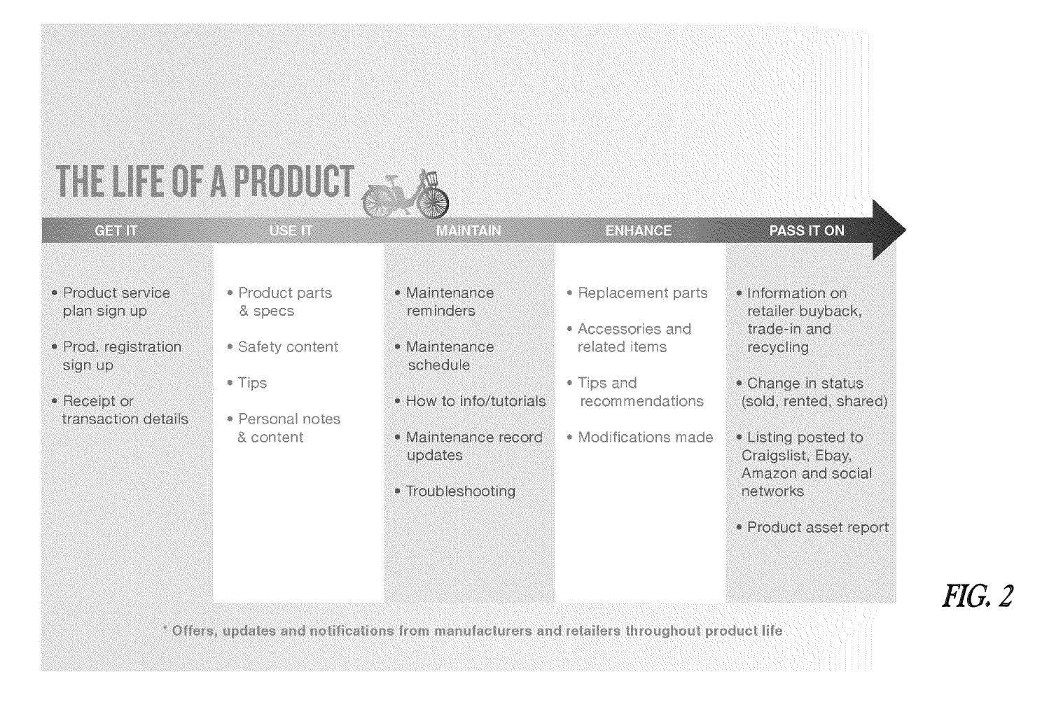

FIG. 2 is a chart illustrating the life of a product in the context of the system. Five stages of product ownership and use are illustrated, starting with “get it”, “use it”, “maintain”, “enhance”, and “pass it on”. Each stage has multiple events and/or information associated with it. During the get it stage, a consumer may sign up for a product service plan, register their product, and provide receipt or transaction details if desired. The use it stage provides information related to product parts and specifications, safety content, tips on use, and personal notes and content that may be provided by the consumer or others. During the maintain stage, maintenance reminders, maintenance schedules, how to information and tutorials, maintenance record updates and troubleshooting advice may be provided. The enhance stage may include information about replacement parts, accessories and related items, tips and recommendations, modifications that may be made, and other information. Some enhance stage information may be provided via the retailer portal in one embodiment. Finally, the pass it on stage may include information on retailer buyback, trade-in and recycling, change in status, such as sold, rented, shared, listings for sale that may be posted to on-line sales and social networks, and even a product asset report. In further embodiments, the system may be used to provide information to an on-line sales site to facilitate the sale of the item. The information may be in the form a link back to the website, and may further include product codes to identify the product. The information at each stage may be varied significantly and include more or less of the information described above in various embodiments.

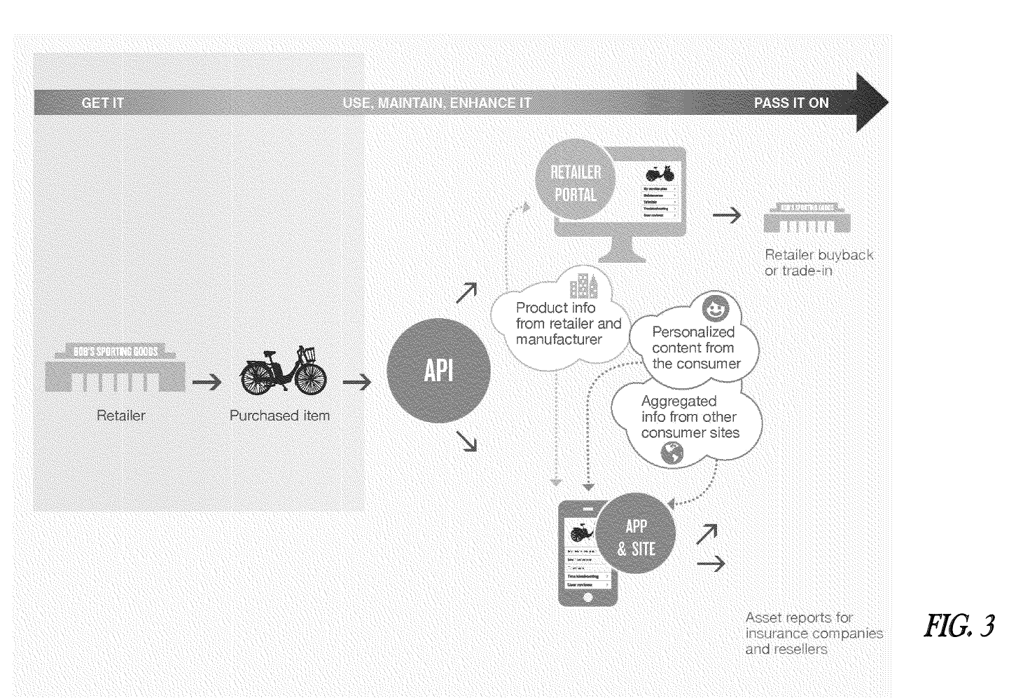

FIG. 3 is a block flow diagram illustrating the involvement of system components during the various stages identified in FIG. 2. Starting from the left side of the figure, the item is purchased from a retailer, such as an online or physical retailer and obtained by the consumer. An API to the system is provided and may be used to obtain information about the product from the retailer via a retailer portal. The product information is added to the site along with personalized content from the consumer and aggregated information from other consumer sites if desired. Asset reports for insurance companies and resellers, such as on-line sites may also be included. A retailer portal may be used to obtain information from the system to facilitate passing the item on via on-line sale.

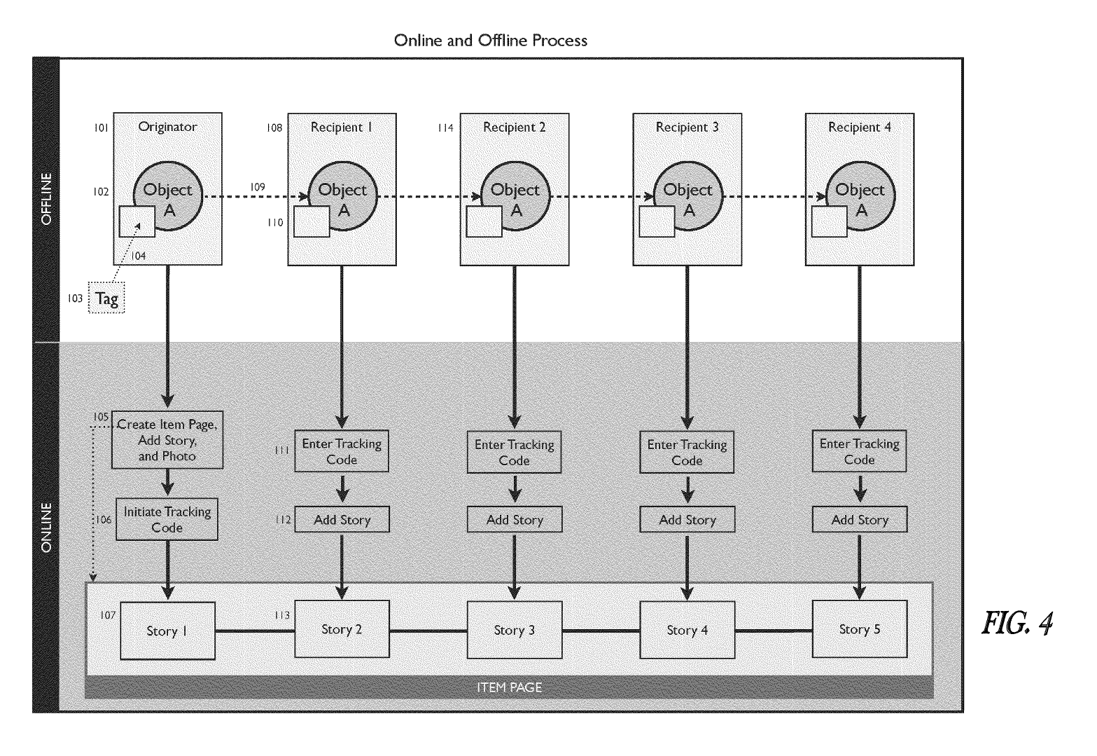

FIG. 4: Online and Offline Process. The process is one example of a process of tracking a product through multiple transfers between recipients of the product.

[101] An originator is the person who initiates the process by physically placing the tracking tag on an object offline and creating an Item Page online. The originator may have purchased the object, or even made the object.

[102] The object can be any physical item to which a tracking code is applied.

[103] Each tag has a unique numerical code. Tags that are large enough also have a unique QR code (Quick Response matrix code and type of two-dimensional bar code that can be read with mobile devices).

[104] Tags are provided with adhesive backings and heat transfer capabilities so that the tags can be applied to a variety of different materials.

[105] Once online, the originator creates an Item Page for the object. Information provided by the originator includes the following: item name, location of object, and type of object. The originator may also be required to upload a photo and add a narrative, such as a story about the object. When creating the Item Page, the originator may select whether the story is private or can be viewed by the public and whether the item is available to be passed on to someone else to possess. Prior to giving the object to someone else, the originator may also select an unlock feature so that the recipient can also add to the story initiated by the originator.

[106] Once the Item Page is created, the tracking code is linked in the database to the specific object on which the tag is placed.

[107] The story written by the originator is visible to the public if the story was marked as public, or visible only to the recipient(s) if marked as private when the story was added. In one embodiment, users of the system are required to obtain an ID and provide a password. The user ID may then be used to track permissions to allow access and adding narratives/photos to item pages.

[108] Recipient 1 is the person who receives the object from the originator offline.

[109] The originator may either give or sell the object to recipient 1, but the object must physically change possession.

[110] The object must also retain the tracking tag placed on it by the originator.

[111] Recipient 1 enters the tracking code to access the information online that was provided by the originator.

[112] Recipient 1 adds his or her own story to the Item Page and upload an optional photo. The recipient may also mark his or her story as public or private and note whether the object is available to be passed on to someone else.

[113] The story written by the recipient is visible to the public if the Item Page was made public, or visible only to the originator and future recipients if marked as private when the story was added.

[114] The process in steps 108-113 may continue indefinitely as long as the object continues to be passed along to other recipients, who may also be referred to as possessors.

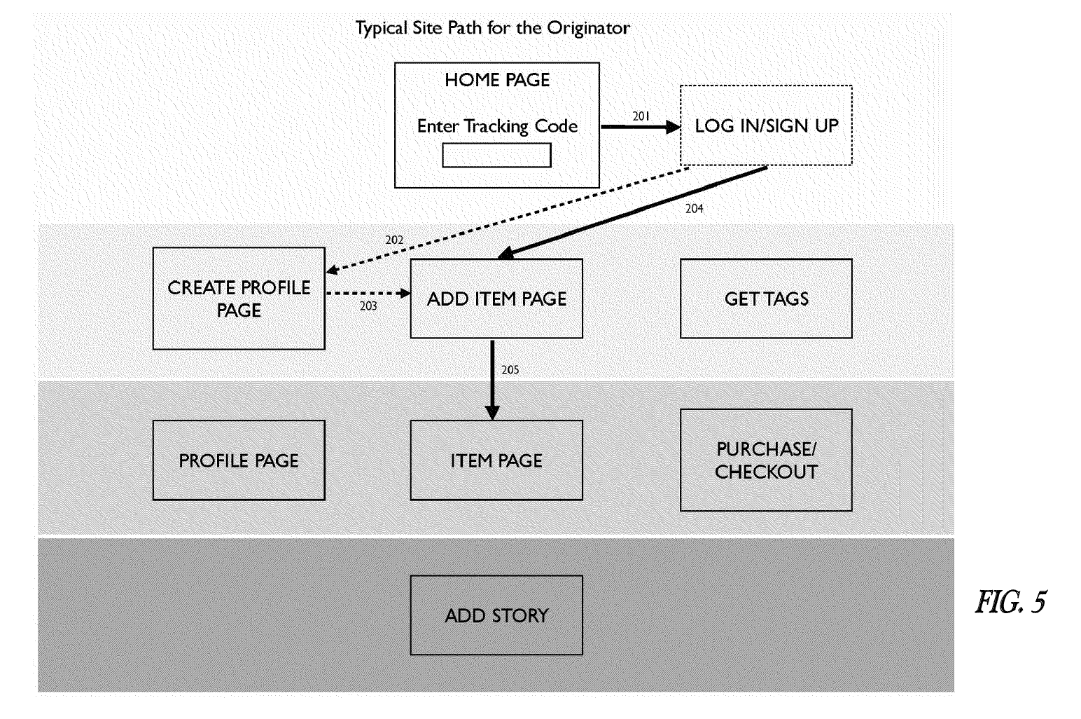

FIG. 5: Typical Site Path for the Originator

[201] Prior to creating an Item Page, the originator may be required to log in.

[202] If the originator does not have a user profile, he or she will be prompted to sign up. The user will be asked to provide a user name, location, and password. Optional information includes a photo and birth date.

[203] Once the user signs up, he or she will be able to create a new Item Page.

[204] If the originator already has a user profile, he or she will log in and be taken directly to the Add Item Page.

[205] The originator can then create an Item Page in which he or she will provide the following information: photo of the item, location of item, type of item, and story about the item. The originator will select whether the story is public or private which determines who can view the story—all users (public) or only the recipient(s) of the item (private). The originator can also select whether the item is available to be given away if he or she does not yet have an intended recipient. Once the item is passed on, the originator may mark the Item Page as unlocked so that the recipient can add to the story.

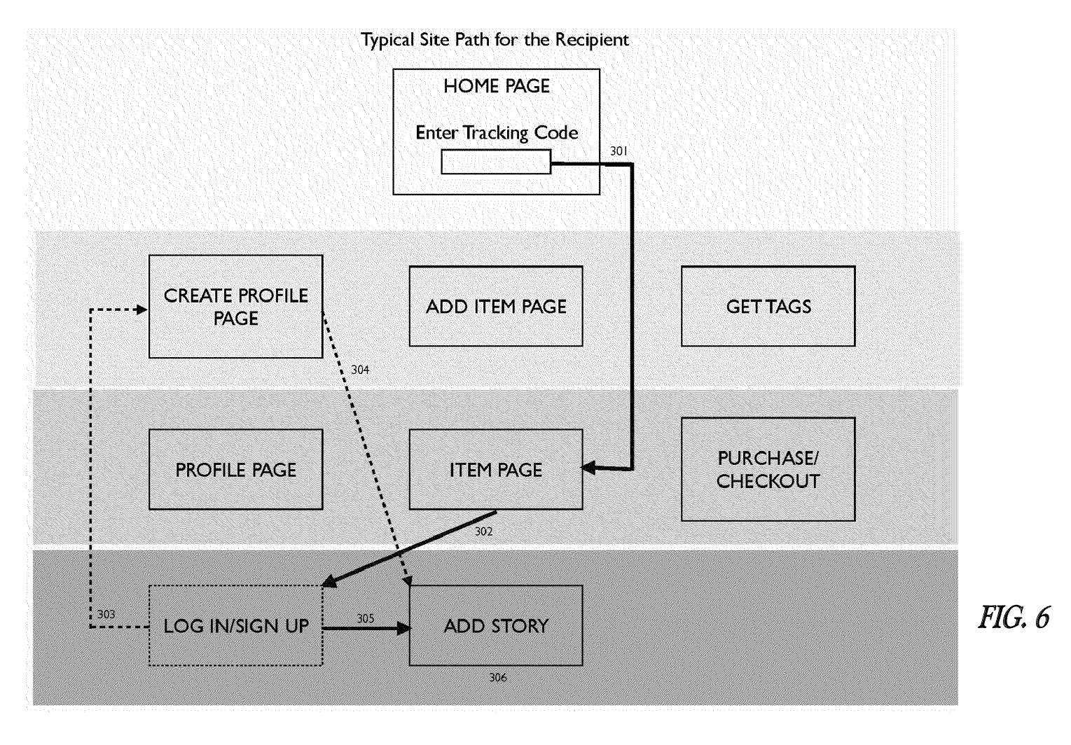

FIG. 6: Typical Site Path for the Recipient

[301] Once a recipient receives an object with a tracking code from another user, the recipient will enter the tracking code to view the Item Page after they have logged in.

[302] Prior to adding a story, the user will be prompted to log in or sign up.

[303] If the recipient does not have a user profile, he or she will be prompted to create a Profile Page.

[304] Once the Profile Page of the new user is created, he or she will be able to access the Add Story Page.

[305] If the recipient already has a user profile, he or she will log in and be taken directly to the Add Story Page.

[306] The recipient can then add a story and provide additional information about the object. The recipient will select whether the story is public or private which determines who can view the story—all users (public) or only the recipient(s) of the item (private). The recipient can also select whether the item is available to be given away if he or she does not yet have an intended recipient. Once the item is passed on, the user will need to mark the Item Page as unlocked so that the next recipient can add to the story. In one embodiment, the private permission level allows all past and future possessors of the item to view the item page and associated narratives/stories.

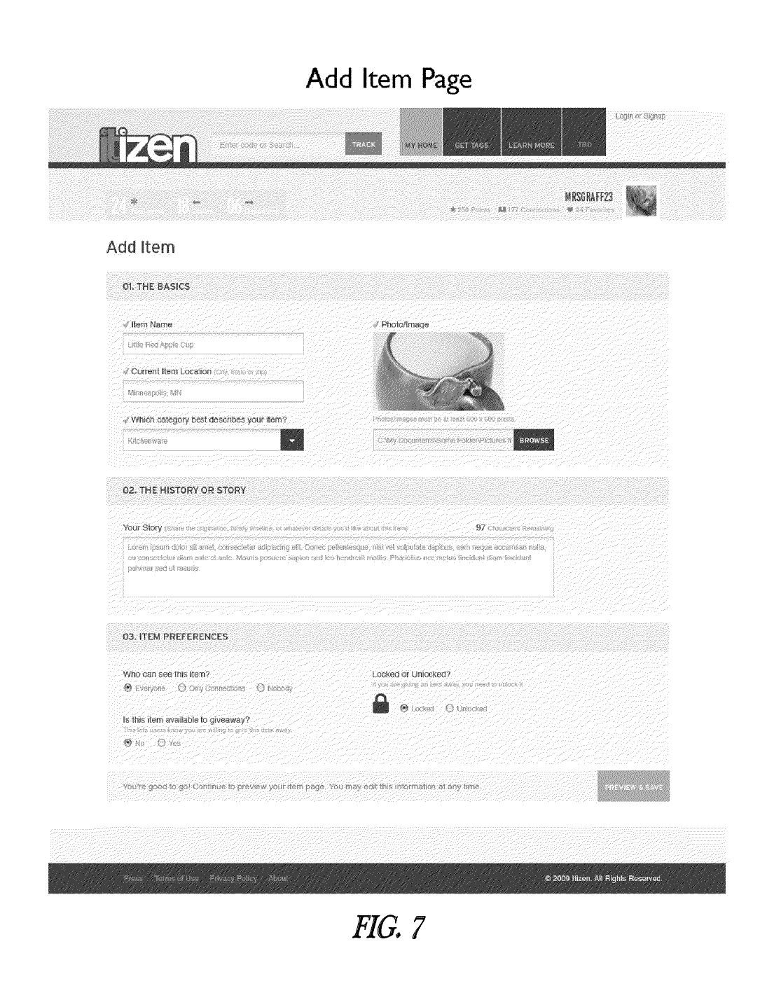

FIG. 7: Add Item Page

The Add Item Page includes a form for entering information on individual items online.

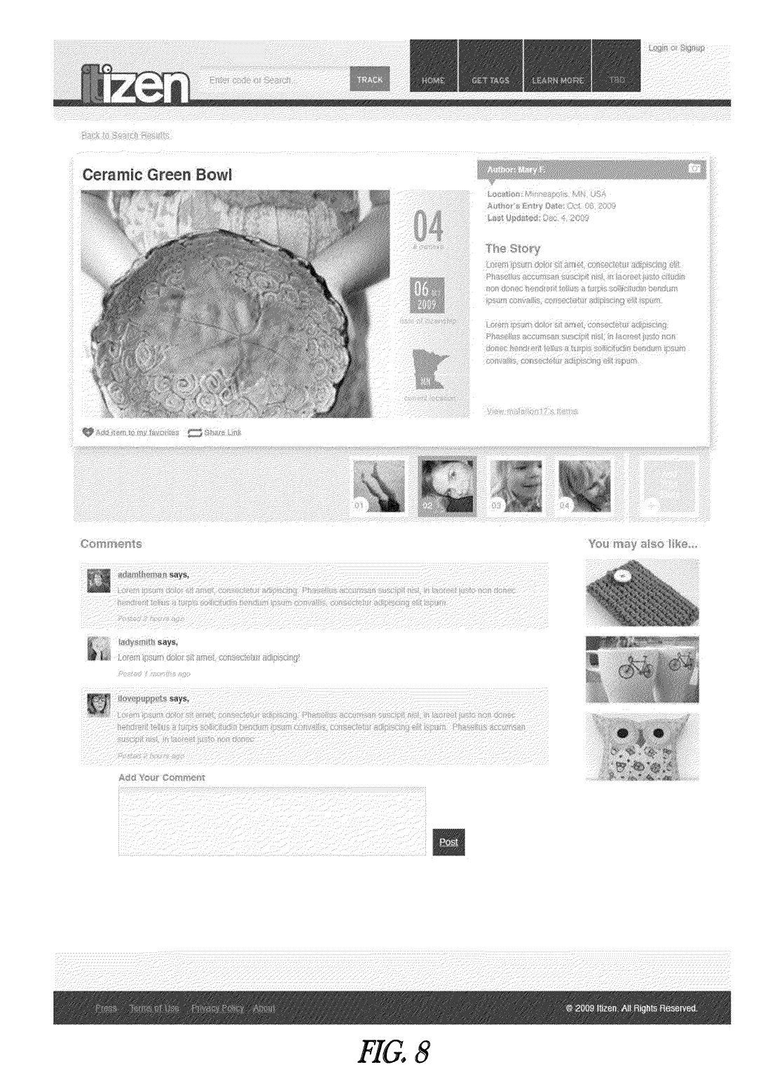

FIG. 8: Item Page

The Item Page is created once information is submitted on the Add Item Page shown in FIG. 7. In addition to including narratives and optional pictures of the item, the Item Page may also include a section for comments by viewers, including past possessors of the object. In one embodiment, only the current possessor may update the narratives section of the Item Page. The Item Page may also include advertisements and links to other sites that may be a function of information in the Item Page, such as item type, and also may be a function of a user profile of the person viewing the Item Page.

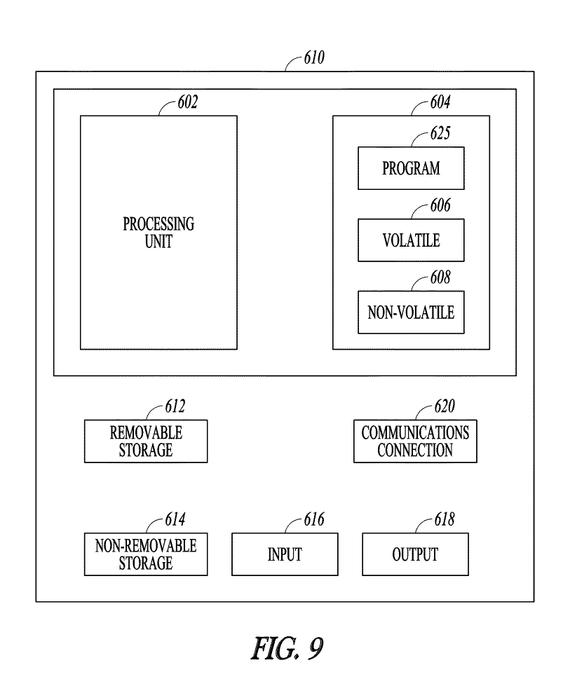

A block diagram of a computer system that executes programming for performing the above algorithm is shown in FIG. 9. A general computing device in the form of a computer 610, may include a processing unit 602, memory 604, removable storage 612, and non-removable storage 614. Memory 604 may include volatile memory 606 and non-volatile memory 608. Computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions to execute methods and algorithms described above may be stored on a computer-readable medium such as illustrated at a program storage device 625 are executable by the processing unit 602 of the computer 610. A hard drive, CD-ROM, and RAM are some examples of articles including a computer-readable medium.

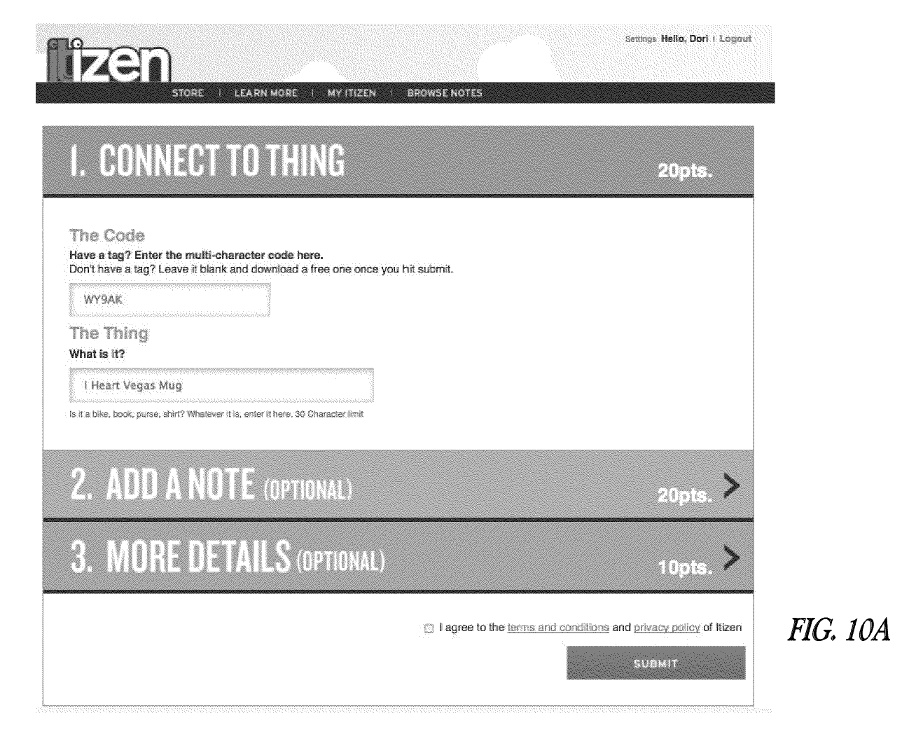

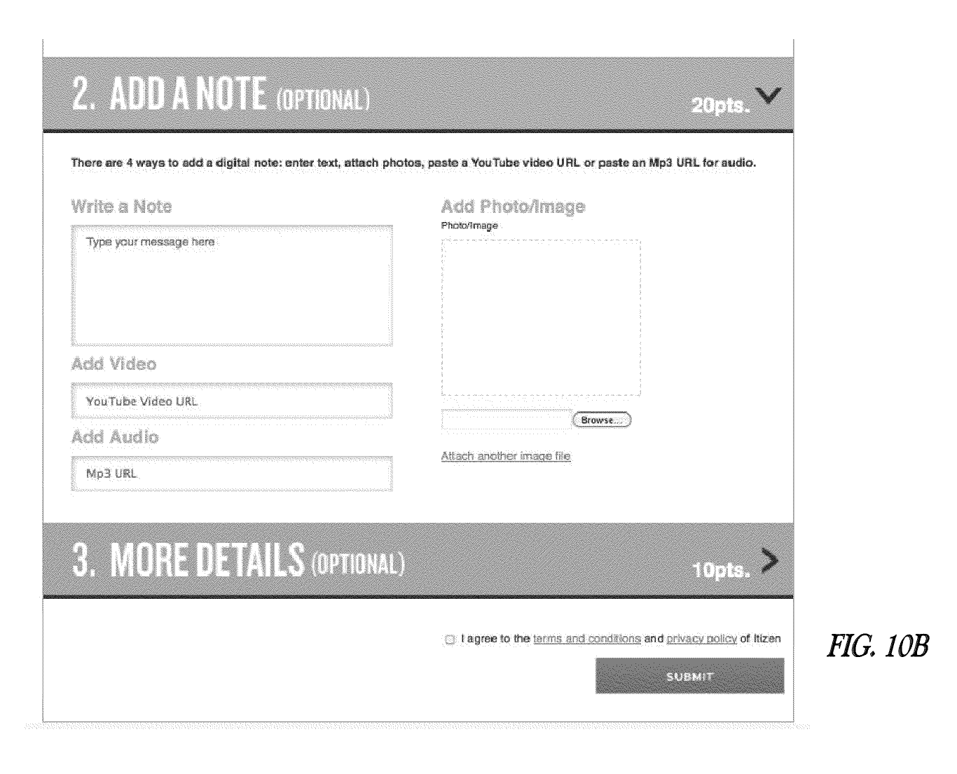

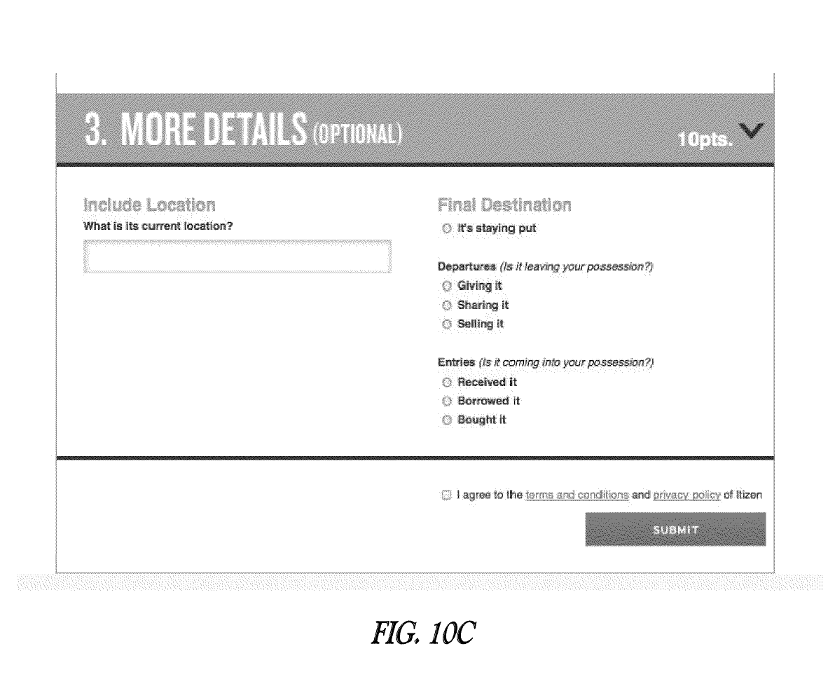

FIGS. 10A, 10B, and 10C are screenshots of an alternative add item page according to an example embodiment. FIG. 10A illustrates a user interface for entering a code corresponding to the item, or alternatively leaving it blank for automatically downloading a code. The thing, such as product, may be described in the interface of FIG. 10 A. Further links are provided to add notes or more details.

In FIG. 10B, a user interface to add a note is provided. The note may be a typed message, a video, or audio in various embodiments. A photo may also be provided. A browse function is provided to facilitate a user finding a file to upload with the corresponding video, audio, or photo/image file.

In FIG. 10C, a user interface is provided to identify the current location of the thing, and also to identify what is happening to the thing, such as staying where it is, departing via gift, sharing, or selling, and entries regarding how the item came into your possession, such as receiving it, borrowing it, or purchasing it.

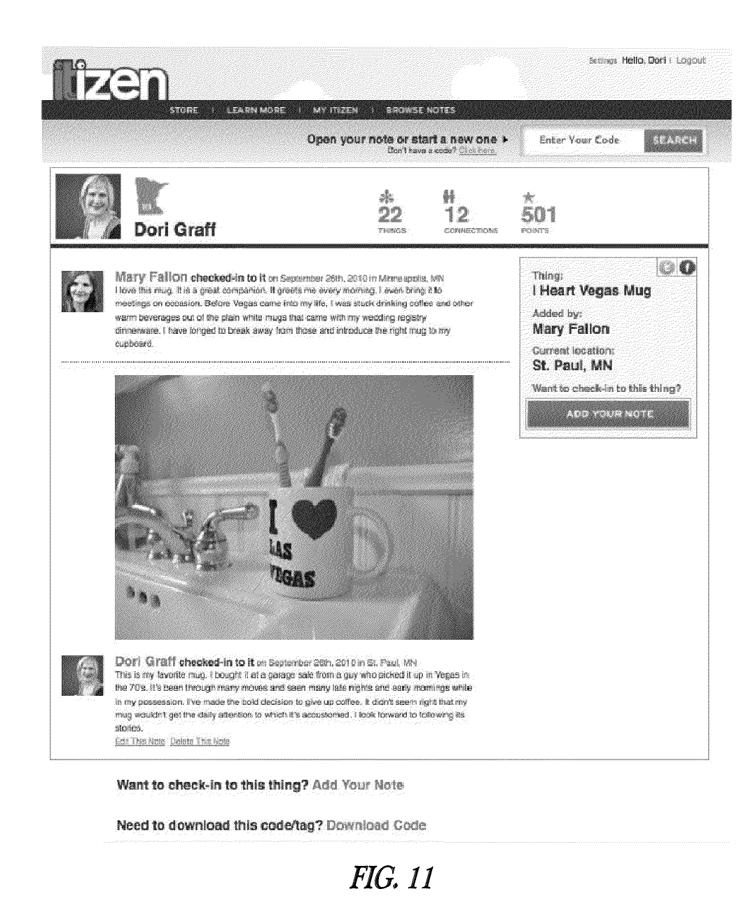

FIG. 11 is a screenshot of an alternative item page with narrative according to an example embodiment. The item page identifies the thing, describes who added it, and its current location, as well as providing a link for adding a note. Existing notes are also shown, along with links for editing notes the user originated.

1. A method comprising:
fixing a tracking tag with a unique tracking identification tag on a physical item to be tracked as possession of the item changes between persons;
creating an item page stored on a storage device and accessible by a network, the item page including an item name, location, and narrative about the item;
when passing the item to another person, allowing the another person to access the item page via the tracking identification tag and add narrative; and
permitting future possessors of the item to view the item page and add to the narrative.

2. The method of claim 1 and further comprising marking the item page private such that only a person in a chain of possession of the item can access the item page, or marking the item page public so the item page is viewable by all.

3. The method of claim 1 wherein the item page facilitates loading a photo of the item when creating the item page.

4. The method of claim 1 wherein the item page facilitates loading a video to the item page.

5. The method of claim 1 wherein each possessor is permitted to mark their corresponding narratives as public to be freely viewable or private such that it is only viewable by current and previous possessors of the item.

6. The method of claim 5 wherein narratives that are marked private are viewable to current and past possessors as a function of a user ID and password of each possessor.

7. The method of claim 6 wherein possessors are required to create a profile page to access private narratives.

8. The method of claim 1 wherein the tracking tag includes a machine readable code that is convertible to an item page address to access the item page via a network connected device.

9. The method of claim 1 wherein the item page is coupled to a third party portal to provide further information regarding the item.

10. The method of claim 9 wherein the third part portal comprises a manufacturer of the item and wherein the portal provides information regarding item maintenance information.

11. The method of claim 10 wherein the third party portal comprises and electronic selling website.

12. A system comprising:
a tracking tag with a unique tracking identification tag affixed to a physical item to be tracked as possession of the item changes between persons;
an item page provided by a computer system accessible by a network, the item page including an item name, and narrative about the item, the system allowing a subsequent possessor of the item to access the item page via the tracking identification tag and add narrative, the system also permitting future possessors of the item to view the item page and add to the narrative.

13. The system of claim 12 wherein the item page contains a selection to make the item page private such that only a person in a chain of possession of the item can access the item page and a selection to mark the item page public so the item page is viewable by all.

14. The system of claim 12 wherein the item page facilitates loading a video, audio recording, and photograph of the item.

15. The system of claim 12 wherein the tracking tag includes a machine readable code that is convertible to an item page address to access the item page via a network connected device.

16. The system of claim 12 wherein the item page is coupled to a third party portal to provide further information regarding the item.

17. A system comprising:
a host computer programmed to provide an item page accessible by a network, the item page including an item name and narrative about the item as a function of a tracking tag with a unique tracking identification tag affixed to a physical item to be tracked as possession of the item changes between persons, the system allowing a subsequent possessor of the item to access the item page via the tracking identification tag and add narrative, the system also selectively permitting future possessors of the item to view the item page and add to the narrative.

18. The system of claim 17 wherein the item page further comprises fields to identify an item location and an item type.

19. The system of claim 17 wherein the item page is coupled to third party portal to provide further information regarding the item.

20. The system of claim 17 wherein the item page is coupled to third party portal to facilitate sale of the item.
